(19) United States
(12) Patent Application Publication
(10) Pub. No.: US 2001/0013517 A1
(43) Pub. Date: Aug. 16, 2001

(54) Tank

(76) Inventors: John Frederick Hart, Palmerston North (NZ); Robin Whitfield, Palmerston North (NZ)

Correspondence Address: DANN DORFMAN HERRELL & SKILLMAN, SUITE 720, 1601 MARKET STREET, PHILADELPHIA, PA, 19103-2307, US

(21) Appl. No.: 09/820,454

(22) Filed: Mar. 29, 2001

Related U.S. Application Data
(63) Continuation of application No. 09/025,655, filed on Feb. 17, 1998.

(30) Foreign Application Priority Data
Feb. 18, 1997 (NZ) 314262

(51) Int. Cl. B60P 3/00; B62D 33/00; B65D 88/12

(52) U.S. Cl. 220/562

(57) ABSTRACT

A tank for an all-terrain vehicle having an operator seat and a carrier frame is of generally tubular form comprising a hollow body portion and a hollow arm portion at one side.

### FIELD

The invention comprises a tank for a ride-on vehicle.

In particular the invention relates to a moulded plastic tank adapted to be seated on a rack or frame at the rear of an all-terrain vehicle (ATV), and to be used in connection with spray apparatus for various spraying applications as desired. However, the tank is not limited to being used in connection with spray apparatus and may be used for other purposes such as carrying water or additional fuel and the tank may also be used with other vehicles such as for example ride-on mowers.

### BACKGROUND

Tanks intended to be carried by an all-terrain motorcycle or vehicle or ATV are already known as evidenced by New Zealand patent application no. 195145/196701 (see FIG. 5) and New Zealand patent application no. 232985. Such tanks include a main body which in use extends across the vehicle and a pair of arms which extend downwardly and forwardly from each end of the body to locate on either side of the vehicle.

### SUMMARY OF INVENTION

The invention proves an improved or at least alternative form of tank.

In broad terms the invention comprises a tank for a ride-on vehicle, comprising a larger capacity hollow body portion and a single smaller capacity hollow arm portion, said body portion extending from a closed end at one side of the tank to said arm portion at its other side and said arm portion extending, when the tank is placed on a ride-on vehicle with the body portion of the tank extending across the rear or front of the vehicle, towards the front or rear respectively of the vehicle and at an angle from the side of the body portion of the tank towards the ground.

In the tank of the invention there are not two arms which define two separate lowermost portions of the tank, but a single arm on one side. One advantage of the invention is that it is not therefore necessary to draw off fluid from the lower end of two arms simultaneously to fully evacuate the tank. This requires the use of two tubes which are joined externally of the tank to form a single supply line to the spray apparatus, and is a cumbersome arrangement with inconvenient external tubing which is vulnerable to damage. The arrangement does not necessarily rule out the possibility of incomplete evacuation of the tank. In addition an arm portion only on one side of the tank does not create an obstruction for the operator in mounting and dismounting from the vehicle, particularly when it is necessary to dismount the vehicle rapidly.

Preferably the shape and dimensions of the body and arm portions of the tank are such that in level use with the tank on a ride-on vehicle and filled substantially to maximum capacity, the centre of mass of the tank and its contents substantially coincides with the mid point across the length of the body portion and the longitudinal axis of the vehicle. In this way optimum weight distribution is achieved when the tank is at maximum or near maximum capacity even though the tank is not systematically shaped relative to the longitudinal axis of the vehicle.

Preferably the cross-sectional area of the interior of the tank decreases gradually from the closed end of the body portion to the remote end of the arm portion of the tank and the body portion of the tank also extends in a continuous curve into the arm portion of the tank. The walls of the body portion are contiguous with the walls of the arm portion.

It will be appreciated that the continuous curved form described above may also be adapted to extend with the body portion across the front of an all-terrain vehicle with the side portion extending rearwardly, following the curvature of the wheel guard of a front wheel.

### BRIEF DESCRIPTION OF THE DRAWINGS

The invention is further described by way of example with reference to the accompanying drawings, in which:

FIG. 1 is a perspective view of an all-terrain vehicle supporting preferred form tank of the invention;

FIG. 2 is an end elevation of the tank shown in FIG. 1;

FIG. 3 is a top plan view of the tank shown in FIG. 1;

FIG. 4 is an end elevation similar to that shown in FIG. 2 except including a cover.

### DETAILED DESCRIPTION OF PREFERRED FORM

FIG. 1 illustrates an all-terrain vehicle 10 having an operator seat 12, behind which a carrier frame 14 is provided. The carrier frame 14 extends over the rear wheel guards 16. The tank 20 is carried behind the operator seat 12 on the carrier frame 14. The tank may be strapped to the frame by ties or suitable straps (not shown) or by bolt-down brackets or other suitable securing means. Alternatively the tank may be carried in a purpose designed mounting bracket or brackets which mount the tank securely to the vehicle.

The tank 20 is of a generally tubular form comprising a hollow body portion 22 which extends across the longitudinal axis of the vehicle, from over the left rear wheel guard (not shown) to over the right rear wheel guard 16. The body portion of the tank has a closed end 23 and the tank extends in a curve around the operator seated on seat 12 contiguously into a hollow arm portion 25 at one side, which in turn curves downwardly and forwardly with the undersurface of the side portion 25 following the curvature of a front portion of the right wheel guard 16.

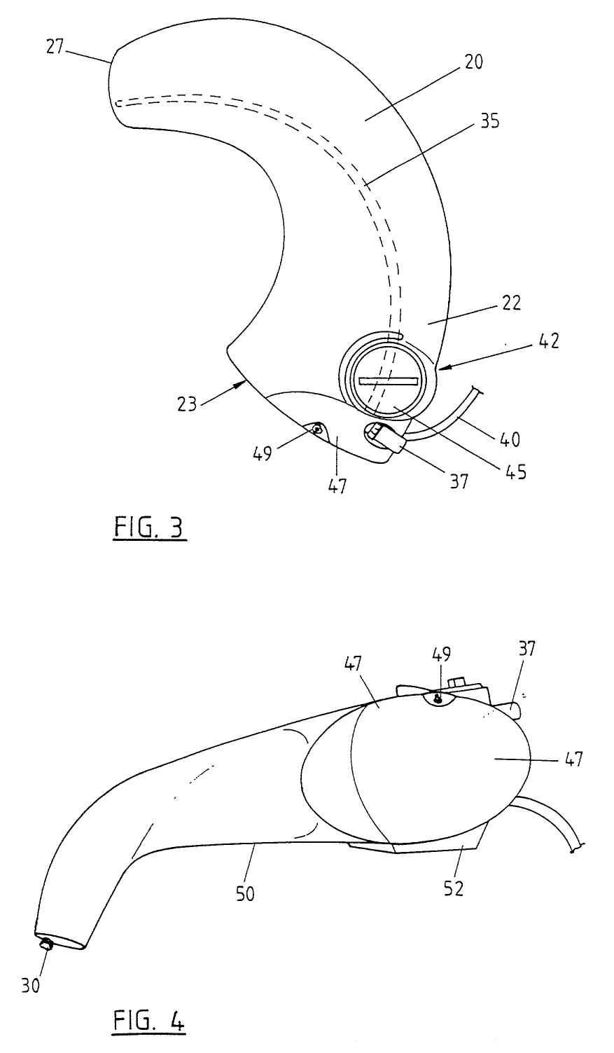

In the preferred form the cross-section of the tank is generally oval or elliptical, lying with its major axis extending horizontally when the tank is mounted as shown on the ATV when on level ground. The body portion and the side portion could alternatively be of a circular, square, or rectangular cross-section. The cross-sectional area gradually decreases from the closed end 23 to the remote end 27 of the arm portion 25. A bung 30 is provided at the remote end of the arm portion 25 as shown in FIG. 4. The tapering dimensions of the tank from one side of the vehicle to the other enables the centre of mass of a substantially full tank 20 to be approximately coincident with the longitudinal axis of the vehicle. This ensures that the vehicle does not become unstable when the tank is full.

The all-terrain vehicle may also be equipped with an additional tank of the invention (not shown) mounted to the front of the vehicle. A carrier frame (not shown) may also be provided on the front of the vehicle on which to secure the additional tank. Such a tank will suitably be oriented with its side portion extending rearwardly. The two tanks may be connected in tandem, such that their contents are drained simultaneously.

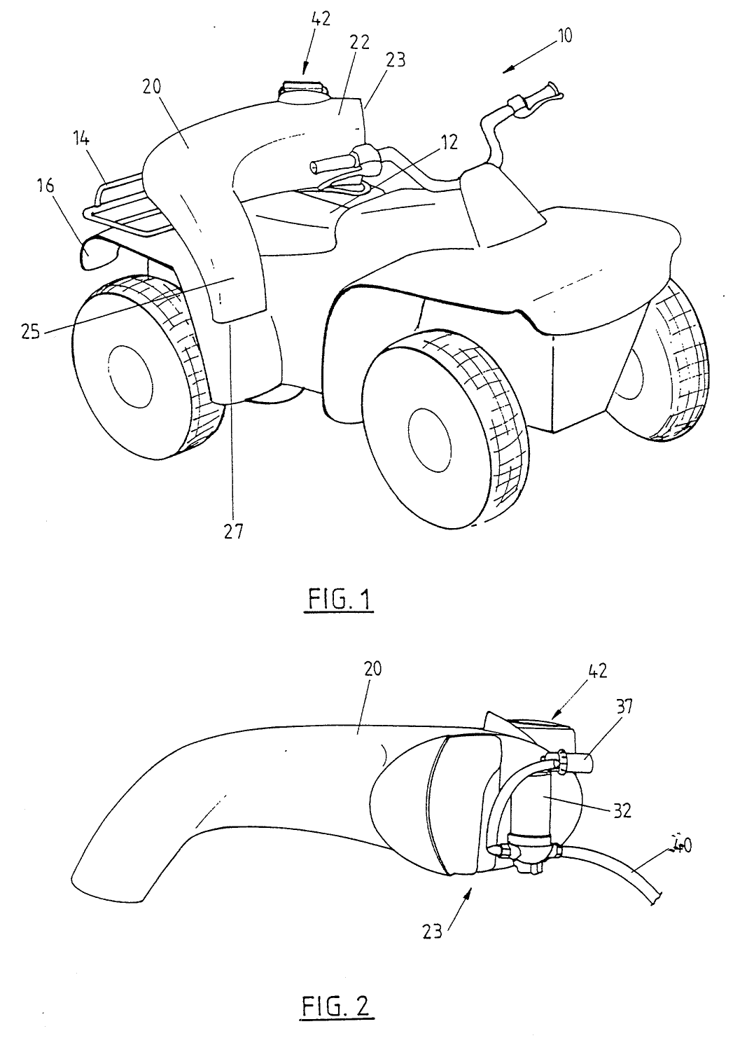

FIG. 2 illustrates in more detail the closed end 23 at which in the preferred form a pump 32 is mounted in the end wall of the tank. The pump 32 is connected to a pump intake tube 35 indicated in FIG. 3 which extends internally within the tank 20 to the remote end 27 of the arm portion of the tank. The end of the tube 35 can locate in a recess provided by the bung to ensure that the tube 35 remains at the lowermost point of the tank 20 to facilitate full evacuation of the tank 20. The pump intake tube 35 is connected to the pump 32 via a filter 37 also mounted on the end wall at the closed end 23 of the tank 20. An outlet pipe 40 connected to the pump 32 may be connected to a hand held spray nozzle or spray nozzles provided on a boom (not shown) extending from the rear of the vehicle 10.

As can be most clearly seen from FIG. 3, the tank 20 is provided with a filler opening 42 in the top surface of the body portion 22 adjacent the closed end 23 of the body portion 22. The filter opening 42 has a lid 45. A screen (not shown) is also provided to ensure that debris does not enter the container through the filter opening 42. An air intake valve (not shown) is also provided in the lid 45 to equalise pressure inside the tank 20 as the tank is being evacuated.

Preferably as illustrated in FIGS. 3 and 4 a cover 47 is provided to extend over the pump housing 32 at the closed end 23 of the tank. The cover 47 has an aperture through which a portion of the filter 37 extends as well as an indent at which an on/off switch 49 is located. The pump may be mounted at other positions such as within a recess moulded into the bottom or side of the tank for example.

To ensure full evacuation of the tank 20, it is necessary that the inner lower surface extends continuously downwardly to ensure that liquid does not pool in any internal cavities in the tank 20. This is achieved by moulding the tank with a lower wall of more or less constant thickness and providing a base portion 52 under the closed end portion of the body portion 22. The base portion 52 may be moulded to form part of the cover 47.

The plastic moulded tank 20 designed for a conventionally sized all-terrain vehicle 10 when designed according to the principles of the present invention can hold approximately 75 liters. The side portion 25 may be provided with graduation marks (not shown) to indicate the quantity of liquid present in a semi-filled tank 20. A handle may also be secured to the body portion 22 to ease carrying of the tank 20 and mounting and dismounting of the tank from the vehicle.

Preferably the tank is formed by rotational moulding from a plastics material. The tank need not be in continuous arcuate tubular form as shown and may easily consist of a straight body portion joined to an arm side portion extending at a 90° angle.

The foregoing describes the invention including a preferred form thereof. Alterations and modifications as will be obvious to those skilled in the art are intended to be incorporated within the scope hereof, as defined in the accompanying claims.

1. A tank for a ride-on vehicle, comprising a larger capacity hollow body portion and a single smaller capacity hollow arm portion, said body portion extending from a closed end at one side of the tank to said arm portion at its other side and said arm portion extending, when the tank is placed on a ride-on vehicle with the body portion of the tank extending across the rear or front of the vehicle, towards the front or rear respectively of the vehicle and at an angle from the side of the body portion of the tank towards the ground.

2. A tank according to claim 1 wherein the shape and dimensions of the body and arm portions of the tank are such that in level use with the tank on a ride-on vehicle and filled substantially to maximum capacity, the centre of mass of the tank and its contents substantially coincides with the mid point across the length of the body portion and the longitudinal axis of the vehicle.

3. A tank according to claim 2 wherein the cross-sectional area of the interior of the tank decreases gradually from the closed end of the body portion to the remote end of the arm portion of the tank.

4. A tank according to any one of claims 1 to 3 wherein the tank has a generally oval or circular cross section over its length along the body portion and around through the arm portion of the tank.

5. A tank according to any one of claims 1 to 4 wherein the body portion of the tank extends in a continuous curve into the arm portion of the tank.

6. A tank according to any one of the claims 1 to 6 in which the bottom of the arm portion of the tank is curved downwardly such that it approximates the curvature of the wheel guard of an all-terrain vehicle.

7. A tank according to any one of the claims 1 to 6 wherein the bottom of the interior of the tank extends, when the tank is placed on a ride-on vehicle, in a downward slope from the closed end of the body portion of the tank to the lower most portion of the tank at the remote end of the arm portion of the tank.

8. A tank according to any one of claims 1 to 7 including a pump attached to the tank and communicating to the interior of the tank.

9. A tank according to claim 8 incorporating an evacuation tube extending from the pump through the interior of the tank to the remote end of the arm portion of the tank.

10. A tank according to any one of claims 1 to 9 including a filler opening through the upper part of the tank adjacent the closed end of the body portion, and a closure cap for the filler opening.

11. A tank according to any one of claims 1 to 10, formed from a plastics material by rotational moulding.

12. A tank substantially as described herein with reference to the accompanying drawings.
